(19) United States
(12) Patent Application Publication
(10) Pub. No.: US 2017/0344927 A1
(43) Pub. Date: Nov. 30, 2017

(54) SKILL PROFICIENCY SYSTEM

(71) Applicant: Accenture Global Solutions Limited, Dublin (IE)

(72) Inventors: Nicole COLETTA, Rockville Centre, NY (US); Shekar Nalle Pilli VENKATESWARA, Vienna, VA (US); Susan GOODYER, Kingston (CA); James H. WACKER, Palatine, IL (US); Nathan M. BOAZ, Atlanta, GA (US)

(21) Appl. No.: 15/187,440

(22) Filed: Jun. 20, 2016

Related U.S. Application Data
(60) Provisional application No. 62/340,859, filed on May 24, 2016.

(51) Int. Cl. G06Q 10/06

(52) U.S. Cl. CPC G06Q 10/063112; G06Q 10/063118

(57) ABSTRACT

A device may include one or more processors. The device may communicate with a first server to obtain data regarding an entity. The data may be stored by a set of data structures of the first server. The device may process the data regarding the entity to determine information relating to one or more data entries of the data. The device may process the information relating to the one or more data entries of the data to generate a classification of the entity. The classification of the entity may be associated with a value corresponding to a particular data entry, of the one or more data entries, satisfying a threshold value. The device may generate one or more recommendations based on the classification of the entity. The one or more recommendations may relate to a role assignment for the entity. The device may communicate with a second server to cause the one or more recommendations to be implemented for the entity.

### RELATED APPLICATION

This application claims priority under 35 U.S.C. §119 to U.S. Provisional Patent Application No. 62/340,859, filed on May 24, 2016, the content of which is incorporated by reference herein in its entirety.

### BACKGROUND

A user interface may be provided via a client device to permit a company to perform surveying to identify a set of skills of a set of employees of the company. For example, the company may provide a group of employees with access to a group of client devices with which to complete a questionnaire, and may utilize results of the questionnaire to determine one or more skills of the group of employees of the company. Additionally, or alternatively, the company may provide an employee with access to a client device with which to complete a test of one or more skills. For example, the company may provide access to a client device to permit the employee to complete a programming test associated with a particular programming language to assess the employee's skill for the particular programming language. The company may select tasks or work assignments for the employee based on results of the questionnaire or the programming test.

### SUMMARY

According to some possible implementations, a device may include one or more processors. The one or more processors may communicate with a first server to obtain data regarding an entity. The data may be stored by a set of data structures of the first server. The one or more processors may process the data regarding the entity to determine information relating to one or more data entries of the data. The one or more processors may process the information relating to the one or more data entries of the data to generate a classification of the entity. The classification of the entity may be associated with a value corresponding to a particular data entry, of the one or more data entries, satisfying a threshold value. The one or more processors may generate one or more recommendations based on the classification of the entity. The one or more recommendations may relate to a role assignment for the entity. The one or more processors may communicate with a second server to cause the one or more recommendations to be implemented for the entity.

According to some possible implementations, a non-transitory computer-readable medium may store one or more instructions that, when executed by one or more processors, may cause the one or more processors to identify a set of roles for a particular employee of a company. Each role, of the set of roles, may be associated with a particular set of skills. The one or more instructions, when executed by one or more processors, may cause the one or more processors to determine, for a particular role of the set of roles, a duration and a recency. The particular role may be associated with a particular skill. The one or more instructions, when executed by one or more processors, may cause the one or more processors to determine a skill proficiency level, of a set of skill proficiency levels, for the particular skill based on the duration and the recency, a value associated with the duration and the recency satisfying a threshold associated with the duration and the recency. The threshold may be associated with the skill proficiency level. The one or more instructions, when executed by one or more processors, may cause the one or more processors to provide information associated with the skill proficiency level based on determining the skill proficiency level.

According to some possible implementations, a method may include communicating, by a device, with one or more server devices including one or more data structures to receive data regarding a first plurality of roles assigned to a plurality of employees of a company. The method may include processing, by the device, the data to determine the first plurality of roles assigned to the plurality of employees of the company. The method may include determining, by the device and for each role of the first plurality of roles, a duration and a recency based on the data. The method may include determining, by the device and for a set of skills associated with the first plurality of roles, a plurality of skill proficiency levels for the plurality of employees based on the duration and the recency for each role of the first plurality of roles. The method may include automatically assigning, by the device, the plurality of employees to a second plurality of roles based on the plurality of skill proficiency levels for the plurality of employees. The method may include providing, by the device, information identifying the second plurality of roles.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for performing a skill proficiency determination; and

FIGS. 5A and 5B are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

An employer may obtain assessment information regarding employees of the employer, such as a set of self-assessment records or supervisor assessment records. Additionally, or alternatively, the employer may perform testing of employees to assess the employees. The employer may determine employee performance based on one or more assessments, and may make staffing decisions based on employee performance. However, staffing based on employee performance may lead to a team of employees that have performed relatively well on a previous project but who lack a particular skill necessary for the team to succeed, such as a management skill, a finance skill, a coding skill, or the like. Moreover, testing may be time-consuming, expensive, and burdensome for employees, and may require computing resources dedicated to performing the testing (e.g., a set of client devices at which a set of employees are to take a test).

The employer may obtain information regarding new employees who have not yet worked on an assignment for which an assessment can be performed. For example, the employer may require a new employee to complete a questionnaire regarding skills possessed by the new employee. Moreover, a recruiter or a manager may attempt to determine skills possessed by the new employee. However, the new employee may exaggerate skills in an interview in order to ensure that the new employee is hired. Moreover, the new employee may have poor subjective judgment regarding how skills obtained based on tasks at a previous job are applicable to tasks that are to be performed at a current job with the employer.

Implementations, described herein, may automatically assess information relating to a duration and recency of assignments performed by an employee of a company to objectively determine a set of skill proficiencies for the employee. Moreover, proximate skills relating to one or more skills of the employee may be automatically identified which may positively contribute to the skill proficiencies determined for the employee. Furthermore, external resumes may be automatically parsed to determine the set of skill proficiencies based on previous work experience with a previous employer, thereby ensuring that a particular employee with skills developed at a previous job is not classified as a novice employee based on a lack of work experience at a current job.

In this way, information identifying skills of an employee may be determined, thereby permitting improved staffing, hiring, and/or training procedures for an employer relative to utilizing a subjective and/or incomplete measure of the employee, such as using a set of assessment results or the like. Moreover, a utilization of computing resources is reduced relative to requiring employees to complete the set of assessments or a set of testing procedures. Based on reducing employee utilization of computing resources, a power consumption and/or a utilization of processing resources is reduced for a group of client devices and/or servers associated with the company. Based on obviating a need for storing a set of records of a set of assessments or a set of questionnaires, a utilization of memory resources associated with storing the records is reduced.

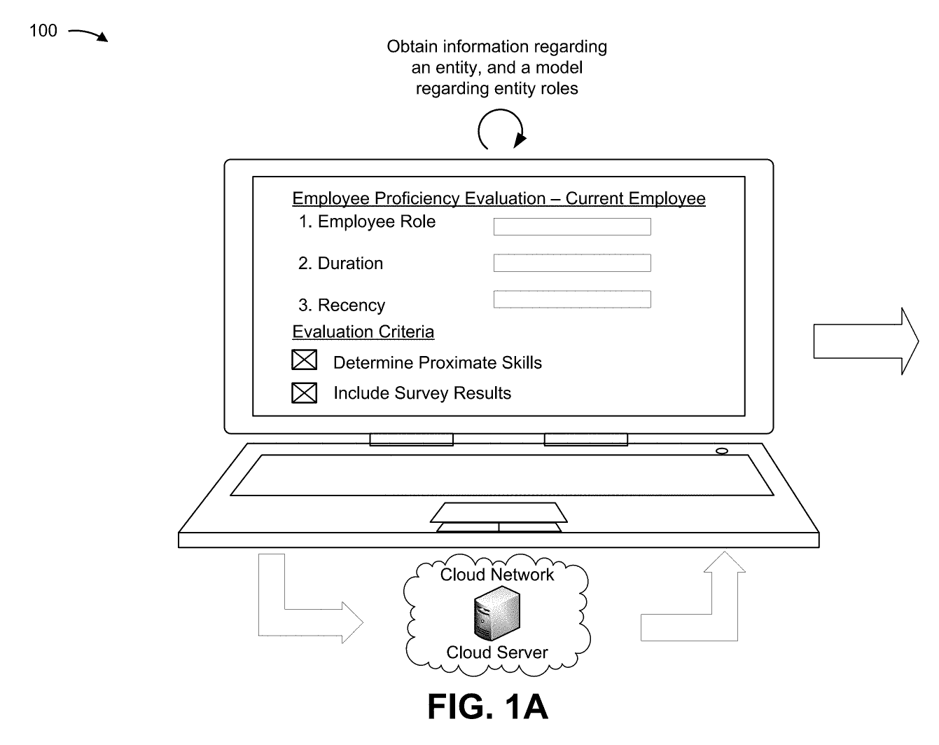

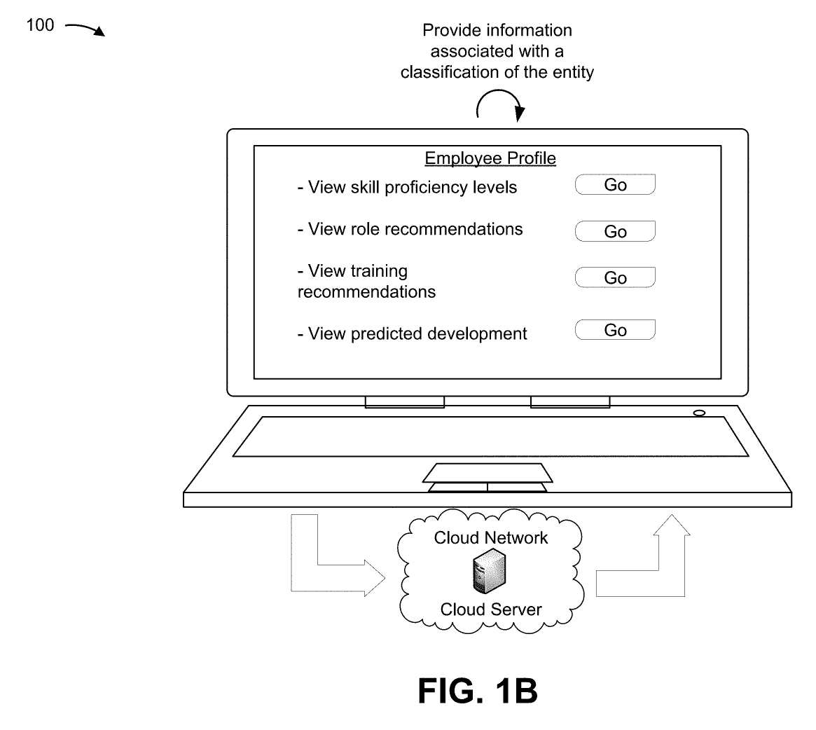

FIGS. 1A and 1B are diagrams of an overview of an example implementation 100 described herein. As shown in FIG. 1A, example implementation 100 may include a client device that receives information from a cloud server of a cloud network.

As further shown in FIG. 1A, the cloud server may cause the client device to provide a user interface to input employee information (e.g., data) associated with a set of employees (e.g., entities who may be identified by data entries of the data) of a company. For example, a user may provide, via input to the user interface, information identifying a role relating to the particular assignment, a duration of the role, a recency of the role, a set of skills utilized to complete the particular assignment, or the like. A role may refer to an employee assignment to a task for an employer, a client of the employer, or the like. For example, a particular employee may be assigned as a developer (e.g., a Java developer, an agileX developer, a web developer, or a mobile application developer), a tester, a consultant, a relationship manager, a financial manager, or the like. In another example, the cloud server may automatically parse a set of records associated with the company and stored via a data structure to determine employee information. For example, the cloud server may obtain information from a task assignment data structure, an employee compensation data structure, or the like to determine a role for an employee, a duration of the role, a recency of the role, a set of skills associated with a role, or the like.

In another example, the cloud server may cause the client device to obtain information associated with validating employee information, such as skills utilized by an employee when the employee is assigned to a particular role. For example, the cloud server may cause the client device to provide a user interface permitting a user to add a set of skills to a role (e.g., an employee assigned to a developer role associated with utilizing a development skill may also utilize a testing skill or a client management skill). Additionally, or alternatively, the cloud server may receive validation information for removing a set of skills from a role (e.g., an employee assigned to a financial manager role associated with a spreadsheet skill requirement may have had another team member perform a spreadsheet task or assignment). In some implementations, the cloud server may transmit information to cause a user interface to be provided to another entity (e.g., a supervisor or a peer of the employee). For example, the cloud server may cause the client device to provide a user interface, for display to a supervisor or peer, to cause input to be received confirming that an employee utilized a set of skills associated with a role to which the employee was assigned at a set of proficiency levels determined by the cloud server.

As further shown in FIG. 1A, the client device may receive a selection of one or more parameters relating to processing the employee information to determine a set of skill proficiency levels for an employee. For example, the client device may receive a selection to determine one or more proximate skills relating to a skill of the employee. A proximate skill may refer to a first (proximate) skill, which is closely related to a second (primary) skill, and for which a particular duration of work experience relating to the first skill contributes to a skill proficiency level for the second skill. For example, an employee may perform an agileX development task (the proximate skill) and may be associated with a particular Java development skill. In this case, when the cloud server determines that agileX development is proximate to Java development, the cloud server may increase the Java development skill proficiency level based on the employee performing the agileX development. In this way, the cloud server incorporates information regarding one or more tasks not directly related to a particular type of skill proficiency level based on the one or more tasks being associated with a skill determined to be similar to the particular type of skill proficiency level.

Additionally, or alternatively, the client device may receive a selection to utilize other information associated with the company. For example, the cloud server may include a set of survey results, a set of testing results, or the like when determining a skill proficiency level for an employee. In this way, the cloud server may incorporate other information regarding an employee to determine a set of skill proficiencies, to adjust a skill proficiency model, or the like.

The cloud server may process the employee information to determine a set of skill proficiency levels for a particular employee. A skill proficiency level may refer to a level of skill an employee is determined to have for a particular task. In some implementations, a skill proficiency level may correspond to an employee's ability to complete a future task similar to the particular task. In some implementations, a skill proficiency level may correspond to a likelihood of a satisfactory performance evaluation provided by a client for the future task. In some implementations, a skill proficiency level may correspond to an amount of time an employee is likely to spend onboarding onto or completing the future task. For example, based on an employee having worked in a development role performing Java development tasks for multiple years, the employee may be classified as having an expert skill proficiency level in Java development, which may indicate less than a threshold quantity of time to onboard to a future Java development task and a threshold likelihood of client satisfaction in the future Java development task. Similarly, an employee with a single month of duration in a Java development task may be classified as having a novice skill proficiency level in Java development.

The cloud server may utilize a skill proficiency model to determine a skill proficiency level. For example, the cloud server may utilize machine learning to process information regarding multiple employees, multiple roles, multiple skills, or the like, and may determine that a threshold quantity of months of duration working in a role involving a particular skill corresponds to a particular skill proficiency level of a set of skill proficiency levels. In some implementations, the cloud server may determine an adjustment to the threshold quantity of months based on a recency of a role. For example, the cloud server may determine that a task performed greater than a threshold amount of time prior to determining the skill proficiency level corresponds to an employee being associated with a lower skill proficiency level. In this way, the cloud server incorporates potential loss of skill over time into a determination of a skill proficiency level for an employee that fails to utilize a particular skill. Moreover, the cloud server may determine that roles or tasks failing to satisfy a threshold recency do not result in a change to a skill proficiency level, and may remove data regarding the roles or tasks failing to satisfy the threshold recency. In this way, the cloud server may reduce a utilization of memory resources relative to maintaining data regarding all roles and/or tasks.

As shown in FIG. 1B, based on receiving information from the cloud server, the client device may provide employee profile information identifying a set of skill proficiency levels for an employee. For example, the client device may provide, via the user interface, information identifying the set of skill proficiency levels for the employee. In some implementations, the client device may provide information identifying a specialization for the employee. A specialization may refer to a clustering of multiple skills for which the employee is associated with a threshold proficiency level. For example, based on an employee being determined to be associated with a threshold proficiency level in mobile application testing, Java development, and client management, the employee may be assigned a specialization—as an on-site tester. This may permit the employer to better identify roles for employees based on multiple related skills. In some implementations, the cloud server may identify a cluster of skills for categorization as a specialization based on identifying a group of skills that are associated with a common role, a group of skill proficiency levels associated with a threshold likelihood of being possessed by a single person, or the like.

Additionally, or alternatively, based on the cloud server automatically assigning the employee to a particular role for a client based on the set of skill proficiency levels, the client device may provide information identifying a set of role recommendations for the employee. Additionally, or alternatively, based on the cloud server identifying a skill proficiency level for the employee that does not satisfy a threshold (e.g., associated with a particular specialization or associated with receiving a particular role recommendation), the cloud server may identify and provide information identifying training recommendations associated with causing the employee to obtain a skill proficiency level that satisfies the threshold.

In some implementations, the cloud server may identify a set of emerging skills based on employee information, information regarding client projects, or the like. For example, the cloud server may determine that a particular skill is being requested at an increasing rate relative to a previous time interval, and may provide a training recommendation associated with ensuring that employees satisfy a particular skill proficiency level for the particular skill. In some implementations, the cloud server may provide a hiring recommendation (e.g., to hire employees satisfying the particular skill proficiency level for the particular skill), a contracting recommendation (e.g., a strategy of subcontracting with another company that includes employees satisfying the particular skill proficiency level for the particular skill), or the like.

Additionally, or alternatively, based on the cloud server analyzing the set of skill proficiency levels of the employee and information regarding a group of other employees, the cloud server may predict development of one or more skills by an employee and may utilize predicted development to automatically identify employees for promotion, for attrition, for retention, or the like, thereby reducing a utilization of computing resources associated with supporting human resources operations.

In another example, the cloud server may receive a resume for the employee, and may utilize a natural language processing technique to parse the resume. In this case, the cloud server may adjust the set of skill proficiency levels of the employee based on skills utilized and/or roles performed for another employer. For example, the cloud server may determine that a first group of employees, who previously worked at Company A, received a skill proficiency level of expert in less time than a second group employees who did not work at Company A (e.g., based on the first group of employees already performing tasks relating to the particular skill at Company A). In this case, the cloud server may determine, for a third employee who also previously worked at Company A, a higher skill proficiency level than had the third employee not previously worked at Company A. In this way, the cloud server permits the company to better understand skills and proficiency levels of employees with experience outside of the company. Similarly, the cloud server may parse a resume of a potential employee to determine a set of skill proficiency levels and may provide a recommendation (e.g., via the user interface of the client device) regarding whether to hire the potential employee.

In this way, the cloud server determines a set of skill proficiency levels for an employee of a company without requiring extensive assessment surveys or testing, thereby reducing a utilization of computing resources and/or a power consumption associated with administering the extensive assessment surveys or the testing. Moreover, the cloud server automatically provides a role recommendation, training recommendations, a hiring recommendation, or the like, thereby reducing a utilization of computing resources associated with manually identifying employees in a database, reviewing employees' work histories, and assigning employees to roles. Furthermore, the cloud server increases a likelihood that an employee is assigned to a task for which the employee is qualified based on the employee's set of skill proficiency levels relative to assigning the employee based on self-assessment, thereby increasing a likelihood that the task is completed without error and reducing a time associated with completing the task, which may reduce a utilization of computing resources associated with completing the task.

As indicated above, FIGS. 1A and 1B are provided merely as an example. Other examples are possible and may differ from what was described with regard to FIGS. 1A and 1B.

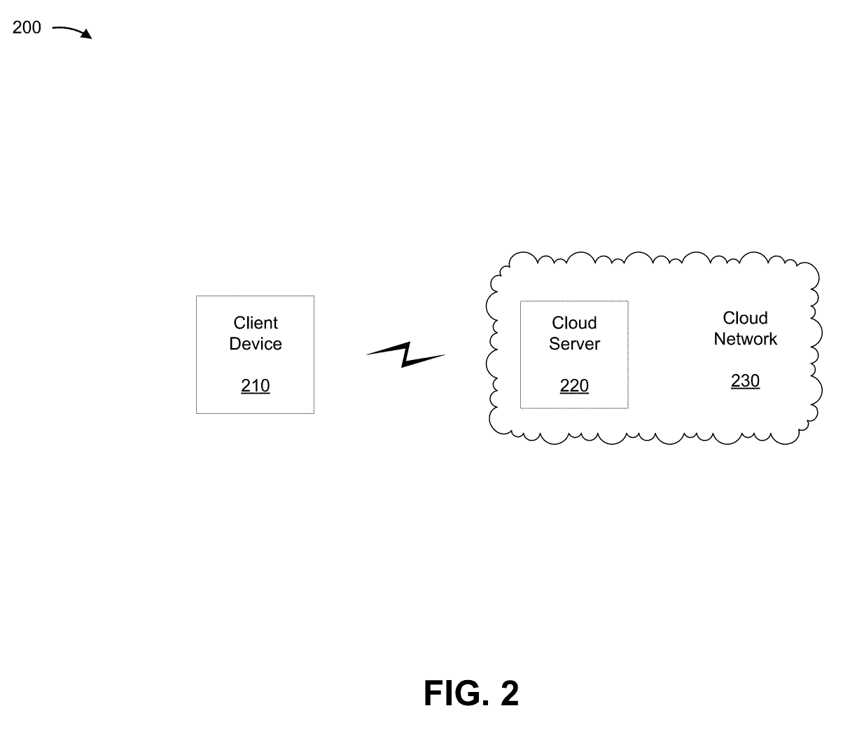

FIG. 2 is a diagram of an example environment 200 in which systems and/or methods, described herein, may be implemented. As shown in FIG. 2, environment 200 may include a client device 210, a cloud server 220, and a cloud network 230. Devices of environment 200 may interconnect via wired connections, wireless connections, or a combination of wired and wireless connections.

Client device 210 includes one or more devices capable of receiving, generating, storing, processing, and/or providing information associated with a set of skill proficiency levels of an employee. For example, client device 210 may include a communication and/or computing device, such as a mobile phone (e.g., a smart phone or a radiotelephone), a computer (e.g., a laptop computer, a tablet computer, a handheld computer, or a desktop computer), a server, a wearable communication device (e.g., a smart wristwatch or a pair of smart eyeglasses), or a similar type of device. In some implementations, client device 210 may receive information from and/or transmit information to another device in environment 200.

Cloud server 220 includes one or more devices capable of storing, processing, and/or routing information associated with a set of skill proficiency levels of an employee. For example, cloud server 220 may include a server that is associated with assigning resources of cloud network 230, directing functionalities of cloud network 230, or the like. In some implementations, cloud server 220 may include a communication interface that allows cloud server 220 to receive information from and/or transmit information to other devices in environment 200. While cloud server 220 is described as a resource in a cloud computing network, such as cloud network 230, cloud server 220 may operate external to a cloud computing network, in some implementations.

Cloud network 230 includes an environment that delivers computing as a service, whereby shared resources, services, etc. may be provided by cloud server 220 to store, process, and/or route information associated with a set of skill proficiency levels of an employee. Cloud network 230 may provide computation, software, data access, storage, and/or other services that do not require end-user knowledge of a physical location and configuration of a system and/or a device that delivers the services (e.g., cloud server 220). As shown, cloud network 230 may include cloud server 220 and/or may communicate with client device 210 via one or more wired or wireless networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. For example, although client device 210 and cloud server 220 are shown as two separate devices, client device 210 and cloud server 220 may be implemented within a single device (e.g., a single device that utilizes cloud-based resources for a portion of processing, data storage, or the like). Additionally, or alternatively, a set of devices (e.g., one or more devices) of environment 200 may perform one or more functions described as being performed by another set of devices of environment 200.

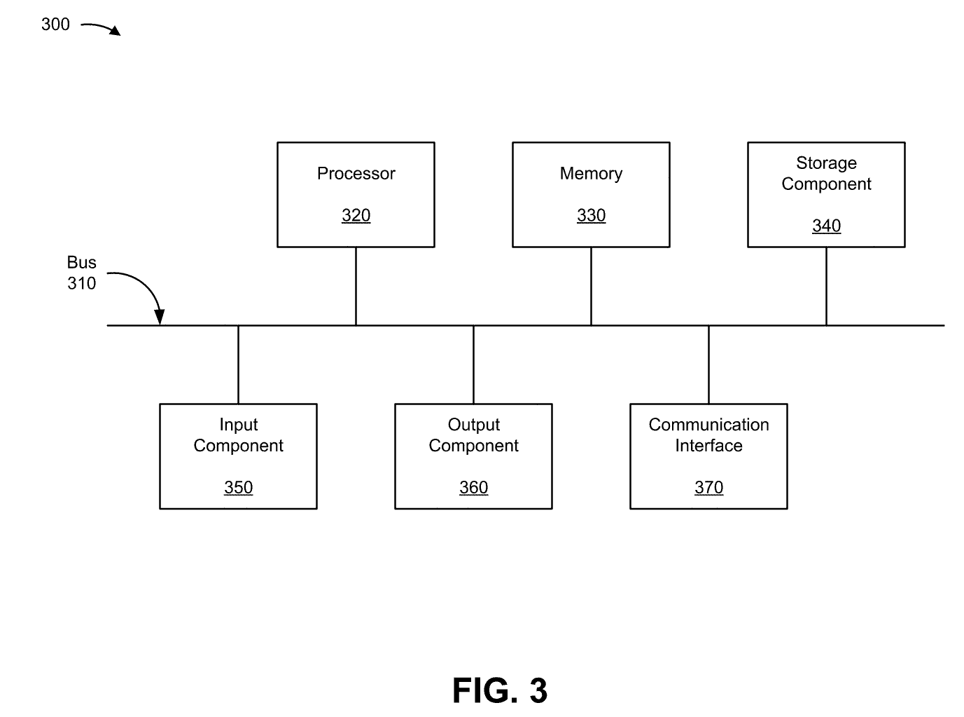

FIG. 3 is a diagram of example components of a device 300. Device 300 may correspond to client device 210 and/or cloud server 220. In some implementations, client device 210 and/or cloud server 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

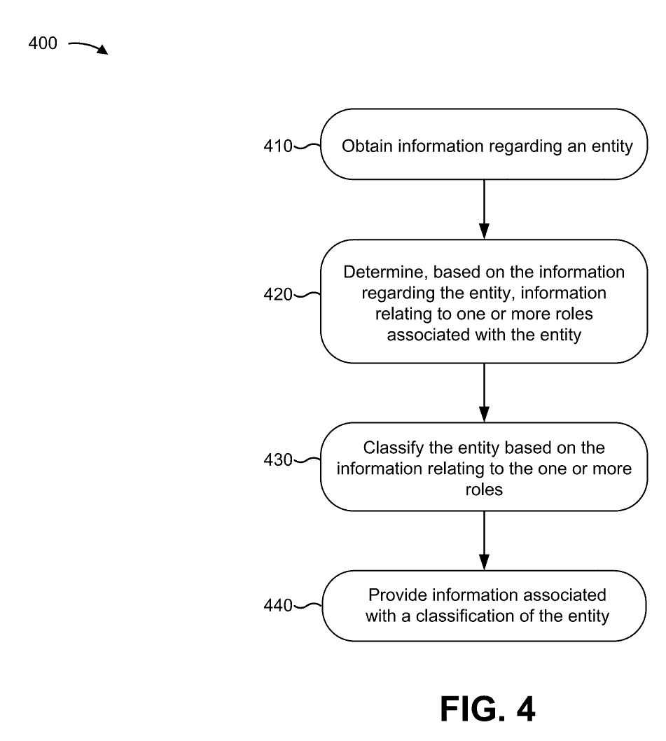

FIG. 4 is a flow chart of an example process 400 for performing a skill proficiency determination. In some implementations, one or more process blocks of FIG. 4 may be performed by cloud server 220. In some implementations, one or more process blocks of FIG. 4 may be performed by another device or a group of devices separate from or including cloud server 220, such as client device 210 or the like.

As shown in FIG. 4, process 400 may include obtaining information regarding an entity (block 410). For example, cloud server 220 may obtain information regarding the entity (e.g., an employee or a potential employee of a company). Information regarding an employee may include information identifying a project to which the employee was assigned, a role of the employee on the project, a task assigned to the employee based on the role, a set of skills associated with completing the task, or the like. For example, cloud server 220 may communicate with a server storing a data structure including data regarding the entity (e.g., storing information regarding the company and/or an employee), and may determine that a particular employee was assigned to a particular role for a project. In this case, based on stored information (e.g., information regarding the project, the particular role, or a set of other roles for a set of other projects), cloud server 220 may determine the set of tasks assigned to the employee and/or the set of skills that are associated with completing the set of tasks.

In some implementations, cloud server 220 may obtain information regarding an employee based on providing a user interface (e.g., via client device 210). For example, cloud server 220 may detect input into the user interface and may receive, based on the input into the user interface, information identifying a role on a project, a task associated with the role, a duration associated with the role, a recency associated with the role, or the like. In some implementations, cloud server 220 may obtain other information regarding an employee, such as a set of results of an employment survey, a set of results of a peer-assessment, a set of results of a self-assessment, a set of results of a supervisor assessment, or the like.

In some implementations, cloud server 220 may parse a resume (e.g., in a document, such as a text document, a portable document format document, or the like or a document available via a social media account, such as a LinkedIn resume, a personal web page resume, or the like) to obtain information regarding an employee or a potential employee. For example, cloud server 220 may utilize a machine learning technique, such as a natural language processing technique or the like, to identify a company at which the employee previously worked, a role of the employee at the company, a skill associated with the role, or the like. In some implementations, cloud server 220 may obtain other information to match the employee to a particular task based on information included in a resume. For example, cloud server 220 may perform an Internet search to obtain information indicating that the company is a software development company for mobile applications, and cloud server 220 may determine that the employee utilzied one or more skills relating to software development for mobile applications. In this way, cloud server 220 may assess experience of an employee or a potential employee to determine a set of skills without requiring subjective self-reporting of skills. Moreover, cloud server 220 may utilize information obtained regarding skills utilized at a previous company to avoid classifying a new employee as a novice based on a lack of roles completed at a current company. Furthermore, based on automatically parsing a resume to obtain information regarding a duration and a recency of a role at a previous company, cloud server 220 may reduce a utilization of processing resources associated with generating a user interface with which to receive information regarding the role.

As further shown in FIG. 4, process 400 may include determining, based on the information regarding the entity, information relating to one or more roles associated with the entity (block 420). For example, cloud server 220 may determine, based on the information regarding the entity, information relating to one or more roles associated with the entity. In some implementations, cloud server 220 may process data obtained from a data structure to determine information relating to one or more data entries of the data. For example, cloud server 220 may process information regarding a company and/or a set of employees to identify a set of roles associated with the set of employees.

In some implementations, cloud server 220 may determine a set of skills associated with the one or more roles. For example, cloud server 220 may receive information identifying a particular skill associated with a particular role, such as a Java development skill associated with a Java developer role, a client management skill associated with a consultant role, a spreadsheet skill associated with a financial manager role, or the like.

In some implementations, cloud server 220 may determine a duration of the role assigned to an employee. For example, when an employee is assigned as a web developer from a first date (e.g., a start date) to a second date (e.g., an end date), cloud server 220 may parse a resume or obtain a data entry from a data structure to determine the first date and the second date, and may determine a length of time for which the employee was assigned as the web developer. In this way, cloud server 220 may determine an amount of experience for the employee at one or more skills associated with the role (e.g., a web development skill or a Hypertext Markup Language (HTML) development skill). In some implementations, cloud server 220 may determine a recency associated with a role. For example, cloud server 220 may determine a period of time that has elapsed from a completion of a role (e.g., an end date) based on parsing a resume or obtaining an end date identifier from a data structure. In this way, cloud server 220 may determine an extent to which one or more skills developed when assigned to the role are fresh or have been diminished over time.

In some implementations, cloud server 220 may utilize an analytics engine to analyze data regarding a company to determine a set of skills associated with a role. For example, cloud server 220 may determine that a set of employees assigned to a particular role for a first project are classified as having a threshold skill proficiency level with a particular skill. In this case, cloud server 220 may determine that the particular role, in a second project, is associated with the particular skill. Additionally, or alternatively, cloud server 220 may determine that, after completing a first one or more tasks associated with a first role, an employee is associated with a threshold likelihood of receiving positive client feedback when performing a second one or more tasks associated a second role. In this case, cloud server 220 may determine that the first role is associated with a particular skill utilized for the second role.

In some implementations, cloud server 220 may determine a set of proximate skills for a particular skill. A proximate skill may refer to a first skill for which experience in a role involving the first skill causes an employee to be at a higher proficiency for a second skill than another employee without experience in the role involving the first skill. For example, cloud server 220 may determine that proficiency in a Java development skill provides experience for a web application development skill. In some implementations, cloud server 220 may determine the set of proximate skills based on employee information. For example, cloud server 220 may identify a first skill and a second skill that are associated with a threshold likelihood of both being required for a role. In this case, cloud server 220 may determine that the first skill is a proximate skill of the second skill. Additionally, or alternatively, cloud server 220 may obtain information from a data structure that stores information identifying proximate skills. For example, based on a questionnaire provided to a human resources expert, a subject matter expert, or the like, information may be obtained identifying proximate skills, and the information may be stored via a data structure. In this case, cloud server 220 may access the data structure to obtain the information identifying the proximate skills

As further shown in FIG. 4, process 400 may include classifying the entity based on the information relating to the one or more roles (block 430). For example, cloud server 220 may classify the entity based on the information relating to the one or more roles. In some implementations, cloud server 220 may process information regarding the entity to generate a classification of the entity. For example, cloud server 220 may determine that a quantity of months for which an employee is assigned to a particular role satisfies a threshold value associated with a particular skill proficiency level.

In some implementations, cloud server 220 may determine a set of skill proficiency levels for a set of skills obtained based on a set of roles. For example, cloud server 220 may determine that an employee was assigned to a particular role, of the one or more roles, for a particular duration, and may determine that the particular duration corresponds to a particular skill proficiency level for a skill associated with the role. In some implementations, cloud server 220 may adjust the skill proficiency level based on a previous skill proficiency. For example, cloud server 220 may determine that the employee was previously associated with a first skill proficiency level and may determine that the particular duration, when added to experience associated with the first skill proficiency level, results in a level of experience of an employee satisfying a threshold associated with a second skill proficiency level.

Additionally, or alternatively, cloud server 220 may adjust the particular skill proficiency level based on a recency of the role. For example, when cloud server 220 determines that an employee completed a role at a time failing to satisfy a threshold recency (e.g., greater than 12 months prior to determining a skill proficiency level for the employee), cloud server 220 may reduce the particular skill proficiency level. In this way, cloud server 220 accounts for a loss of skill over time, thereby reducing a likelihood that an employee who has forgotten a particular skill is determined to be qualified for a particular role relative to utilizing a static assessment of skills. Based on reducing the likelihood that the employee has forgotten the particular skill, cloud server 220 increases a likelihood that the employee is selected to perform a particular role for which the employee is qualified, therefore reducing a quantity of computing resources associated with debugging program code associated with the particular role, revising errors associated with the particular role, or the like relative to a less qualified employee being selected.

In some implementations, cloud server 220 may adjust a skill proficiency level based on a type of skill. For example, cloud server 220 may determine that a first skill requires a first threshold amount of time to obtain a particular skill proficiency level and that a second skill requires a second threshold amount of time to obtain the particular skill proficiency level. In some implementations, cloud server 220 may determine that the particular skill is an emerging skill (e.g., a skill being required for roles with an increasing frequency of occurrence relative to one or more other skills), and may reduce a threshold amount of time to obtain a particular skill proficiency level based on the skill being emerging (e.g., based on the skill being new).

In some implementations, cloud server 220 may adjust a skill proficiency level threshold based on skill proficiencies of one or more employees, and may adjust a particular skill proficiency level for a particular employee based on adjusting the skill proficiency level threshold. For example, cloud server 220 may initially determine a relatively short duration for achieving a particular skill proficiency level for a particular skill (e.g., to reflect that a relatively small amount of experience at an emerging skill causes an employee to be an expert relative to other employees), and may subsequently (e.g., after other employees have attained experience at the emerging skill) determine a relatively long duration for achieving the particular skill proficiency level (e.g., to reflect that a larger amount of experience at the emerging skill causes the employee to be an expert relative to other employees). In this case, cloud server 220 may adjust a skill proficiency level of a particular employee based on adjusting a threshold duration of experience in a role associated with the particular skill proficiency level.

In some implementations, cloud server 220 may adjust a skill proficiency level of an employee based on a proximate skill proficiency level of the employee. For example, when cloud server 220 determines that a duration and recency of a role for the employee indicate a novice skill proficiency level and that the employee has experience in a proximate skill, cloud server 220 may adjust the skill proficiency level for the skill being assessed to a higher proficiency level based on the duration and the recency of the role where the proximate skill is being used. In this way, cloud server 220 accounts for experience in a proximate skill improving an employee's ability at the particular skill.

In some implementations, cloud server 220 may utilize a machine learning technique to determine a set of weights to apply to a set of factors (e.g., duration, recency, or type of skill) when determining a skill proficiency level for a particular role of the one or more roles. For example, cloud server 220 may analyze employment outcomes (e.g., self-assessments, supervisor assessments, or client assessments) of employees performing roles associated with a particular skill to determine an amount of experience, a recency, or the like that corresponds to classifying an employee at a particular level of expertise (e.g., an expert is associated with a first threshold likelihood of a positive assessment and a novice is associated with a second, lower threshold likelihood of a positive assessment). In this way, cloud server 220 may automatically determine a skill proficiency level for an employee, without requiring the set of factors to be provided to cloud server 220, thereby reducing an amount of computing resources utilized to provide the set of factors each time a new skill or a new role is to be added.

In some implementations, cloud server 220 may validate a determination of a skill proficiency level. For example, cloud server 220 may provide information identifying a determined skill proficiency level for an employee and may receive input, via a user interface, identifying a supervisor or peer assessment of whether the selected skill proficiency level is accurate. In this case, cloud server 220 may adjust the skill proficiency level based on the input. In this way, cloud server 220 reduces a likelihood that a skill proficiency level determination results in an employee being selected for a role for which the employee is not qualified or failing to be selected for a role for which the employee is qualified. Additionally, or alternatively, based on validating the determination of the skill proficiency level, cloud server 220 may adjust an analytical data model associated with determining one or more skills that are associated with a role, a duration of a role that is associated with the a particular skill (e.g., an on-site tester role may include 1 month of client counseling for every 12 months of work or a financial manager role may include 12 months of client counseling for every 12 months of work), or the like. For example, cloud server 220 may determine that, for a particular skill, a calculated skill proficiency level is determined to be less than an assessment-based skill proficiency level with a threshold likelihood, and may adjust an analytical data model associated with determining the skill proficiency level to cause subsequent calculated skill proficiency levels to match assessment-based skill proficiency levels.

In some implementations, cloud server 220 may determine a specialization for an employee based on one or more skill proficiency levels associated with one or more skills. For example, cloud server 220 may determine that a particular set of skills, of the one or more skills, for which an employee satisfies a threshold level (e.g., an expert level, an advanced level, or a moderate level), corresponds to a particular specialization. In some implementations, cloud server 220 may utilize a machine learning technique to identify a specialization. For example, cloud server 220 may apply a clustering analysis technique to a set of skills associated with an employee and information regarding skills of other employees to identify a specialization for the employee.

As further shown in FIG. 4, process 400 may include providing information associated with a classification of the entity (block 440). For example, cloud server 220 may provide information associated with the classification of the entity. In some implementations, cloud server 220 may provide an employee profile for a particular employee based on the classification. For example, cloud server 220 may provide information identifying a set of skill proficiency levels for the employee, a specialization of the employee, or the like. In some implementations, cloud server 220 may provide information, such as a recommendation, associated with a task assignment. For example, based on a set of skill proficiency levels of the employee, cloud server 220 may communicate with one or more server devices storing one or more data structures of task assignments or project assignments to automatically recommend or assign the employee to a particular role for a particular project (e.g., a role associated with utilizing skills for which the employee has a threshold skill proficiency level), and cloud server 220 may provide information identifying the particular role and/or one or more tasks associated with the particular role.

In some implementations, cloud server 220 may provide information identifying a predicted set of skill proficiency levels for an employee. For example, cloud server 220 may utilize a pattern matching technique, a machine learning technique, a heuristic technique, or the like to analyze a set of skill proficiency levels of the employee and predict a future skill proficiency level of the employee based on one or more skill proficiency levels of one or more other employees. In some implementations, cloud server 220 may provide a recommendation relating to employee compensation, employee promotion, employee retention, or the like based on the predicted set of skill proficiency levels, thereby ensuring that a company retains employees with a greatest predicted potential. In some implementations, for a particular employee, cloud server 220 may identify a data structure storing salary information, may identify one or more similarly skilled employees at similar companies for whom salary information is available via the data structure, and may make a salary offer to the particular employee based on the salary information for the one or more similarly skilled employees. This may reduce a likelihood that a company must hire a new employee with a relatively low skill proficiency level, thereby reducing a utilization of computing resources relative to training the new employee, relative to the new employee requiring additional time to complete a task, or the like.

In some implementations, cloud server 220 may provide a training recommendation or an education strategy for a company based on the set of skill proficiency levels. For example, cloud server 220 may identify an educational unit for completion by an employee to increase a skill proficiency level. In some implementations, cloud server 220 may automatically identify one or more educational units, such as by searching the Internet for an educational course utilizing one or more search terms corresponding to a skill associated with the skill proficiency level. Additionally, or alternatively, cloud server 220 may determine that a group of employees are associated with a skill proficiency level failing to satisfy a threshold, and may recommend that a company generate a training unit and provide the training unit to the group of employees, thereby reducing a utilization of computing resources relative to each employee being required to separately obtain educational information regarding a skill.

In some implementations, cloud server 220 may provide a recommendation regarding a hiring strategy of a company. For example, cloud server 220 may provide information indicating that a particular emerging skill (e.g., a skill being requested by client companies at a frequency satisfying a threshold relative to one or more other skills or a skill that is determined to be new relative to one or more other skills, such as proficiency in a newly developed programming language or software) is not possessed at a threshold skill proficiency level by a threshold quantity of employees of the company, and may determine an action that the company may take to ensure that the particular emerging skill does not prevent the company from performing work. In this case, cloud server 220 may automatically perform analysis (e.g., a cost-benefit analysis) regarding hiring a new employee, training a current employee, or subcontracting with another company to ensure that the particular emerging skill is acquired for a project, and may provide information identifying a result of the analysis. In some implementations, cloud server 220 may automatically identify the other company, such as via a web search using a search term associated with the emerging skill.

In some implementations, cloud server 220 may provide information regarding one or more employees based on performing a classification of one or more employees in real-time or near real-time. For example, cloud server 220 may receive a request to identify an employee with a threshold skill proficiency level for a particular skill, and may identify the employee based on receiving the request. In this way, cloud server 220 may increase an accuracy and reduce an amount of time to identify an employee to perform a task relative to requiring a questionnaire regarding an employee's skills to be completed based on subjective opinion each time a task is to be staffed.

In some implementations, cloud server 220 may periodically update a proficiency level of an employee, and may provide updated information associated with an updated proficiency level. For example, cloud server 220 may determine that an employee classification is to be adjusted from a first skill proficiency level to a second skill proficiency level based on an updated duration (e.g., after an employee works at a role for a period of time), an updated recency (e.g., after a period of time has elapsed from an employee completing work at a role), or the like. In this case, cloud server 220 may determine an updated recommendation based on the employee being associated with the second skill proficiency level, and may provide information identifying the updated recommendation. In some implementations, cloud server 220 may utilize an application programming interface (API) command to communicate with a human resources system. Additionally, or alternatively, cloud server 220 may automatically receive updated information from the human resources system, and may update the classification of the employee based on receiving the updated information. In this way, cloud server 220 automatically maintains up to date skill proficiency information for a set of employees, permitting staffing decisions to be made more rapidly than utilizing questionnaires or survey results.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

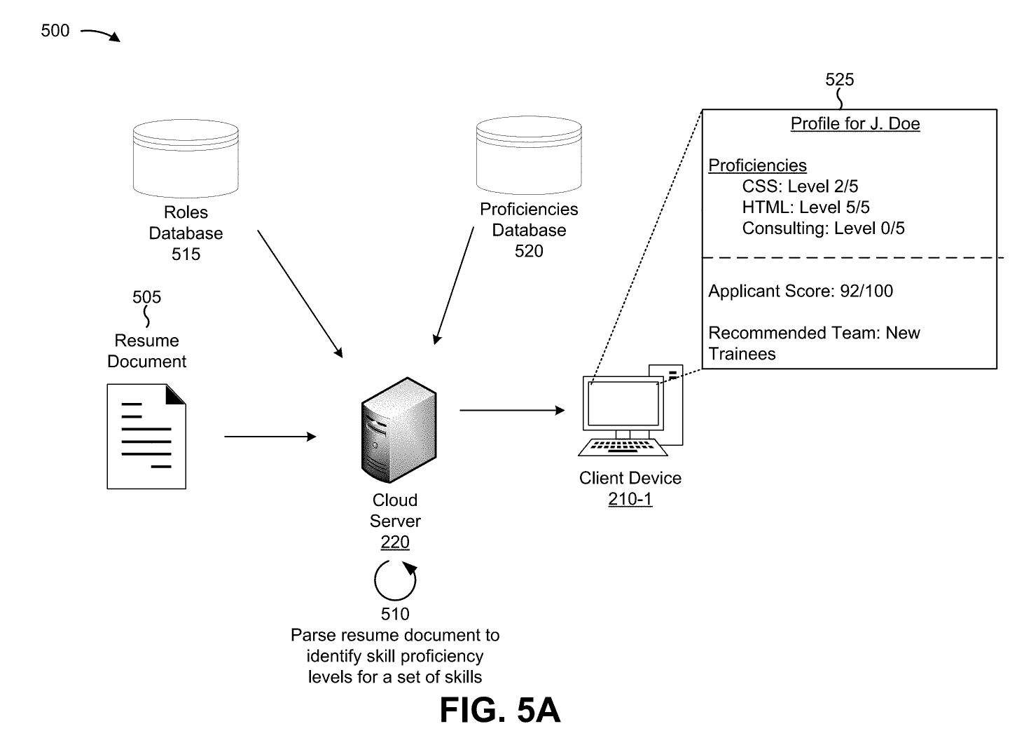

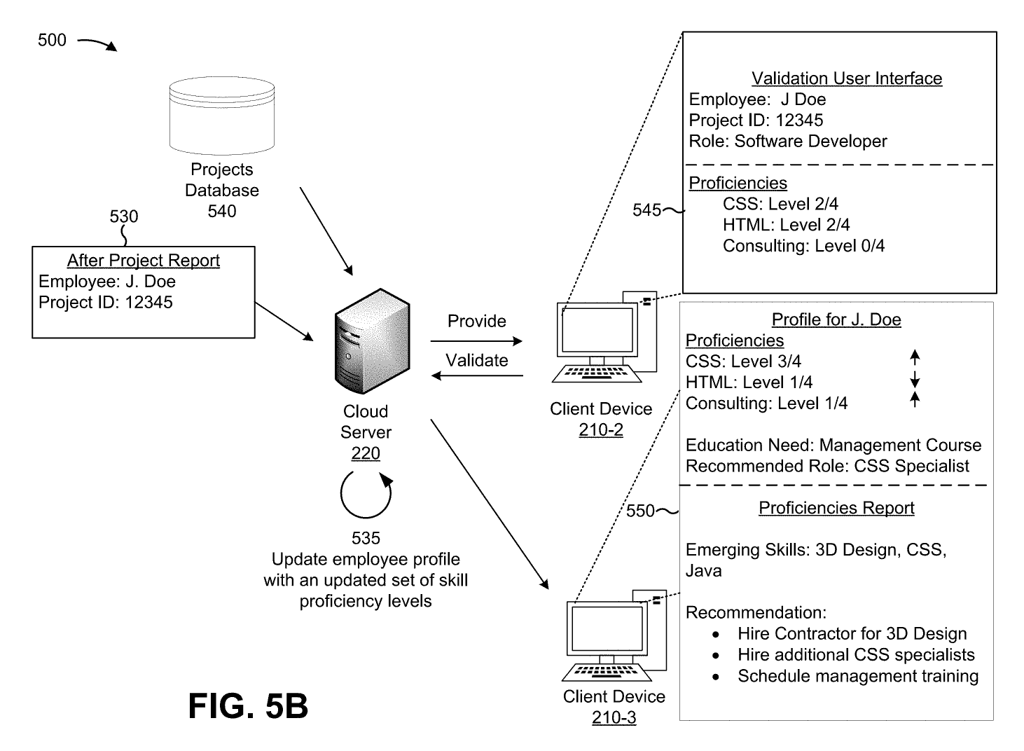

FIGS. 5A and 5B are diagrams of an example implementation 500 relating to example process 400 shown in FIG. 4. FIGS. 5A and 5B show an example of performing a skill proficiency determination.

As shown in FIG. 5A, and by reference number 505, cloud server 220 receives a resume document (e.g., based on a submission via a job application portal) for a potential employee. As shown by reference number 510, cloud server 220 parses the resume document to identify skill proficiency levels for a set of skills. For example, cloud server 220 utilizes a natural language processing technique and information from roles database 515 (e.g., storing information identifying types of roles) to identify the set of roles identified in the resume document. Further to the example, cloud server 220 utilizes a natural language processing technique to identify a set of factors associated with the set of roles (e.g., a duration of a role, a skill associated with the role, or a task performed in a role) based on information stored by proficiencies database 520 (e.g., information identifying the set of factors, a set of weightings to apply to the set of factors, or the like). In this way, cloud server 220 identifies a set of skill proficiency levels for the set of skills associated with the set of roles. As shown by reference number 525, cloud server 220 causes client device 210-1 to provide a profile for the potential employee based on the set of skill proficiency levels. The profile includes information identifying the set of skill proficiency levels and a score for the potential employee based on the set of skill proficiency levels and relative to one or more other potential employees. The profile includes information identifying a recommended team that the potential employee is to be assigned to if the potential employee is hired. In another example, cloud server 220 may store information identifying the profile for utilization at a subsequent time (e.g., based on updating the profile). Assume that the potential employee is hired as an employee, and subsequently (e.g., after training on a New Trainees team) is assigned to a particular role for a particular project.

As shown in FIG. 5B, and by reference number 530, cloud server 220 receives an after project data file regarding the particular project. The project data file includes information indicating that the employee was assigned to the particular project and performed the particular role for which the employee was assigned (e.g., Validated Role: Yes, indicating that the particular role for which the employee was assigned was the role that the employee performed, rather than the employee performing other tasks on the project). As shown by reference number 535, cloud server 220 updates an employee profile for the employee with an updated set of skills and their corresponding proficiency levels (e.g., an updated classification of the employee). For example, cloud server 220 obtains information from projects database 540 identifying the particular role for the particular project, a duration of the particular project, a set of skills associated with the particular role, or the like, and updates a set of skill proficiency levels for the employee (e.g., based on the employee performing the particular role and based on skills determined based on the resume document).

As shown by reference number 545, cloud server 220 causes client device 210-2 to provide an validation user interface for displace. The validation user interface includes information identifying the role and a set of calculated proficiency levels based on being assigned to the role and utilizing skills during completion of assignments related to the role. Cloud server 220 may receive validation information indicating that the calculated proficiency levels are accurate for the employee (e.g., based on a review by a supervisor). In another example, cloud server 220 may generate an updated employee profile without requiring validation. As shown by reference number 550, cloud server 220 causes client device 210-3 to provide the updated employee profile and a skill proficiencies report for display. The updated employee profile includes information identifying an updated set of skill proficiency levels, a training recommendation based on the updated set of skill proficiency levels, and a work assignment recommendation based on the set of skill proficiency levels. The skill proficiencies report includes information regarding skills associated with employees of the company. For example, cloud server 220 provides information identifying a set of emerging skills, a hiring recommendation for a first emerging skill, a hiring recommendation for a second emerging skill, and a training recommendation for a non-emerging skill based on sets of skill proficiency levels for a set of employees. In this way, cloud server 220 automatically generates information relating to hiring of an employee and/or assigning the employee to a project based on a determination of a set of skill proficiency levels, thereby reducing a likelihood that a new employee with extensive prior experience is assigned to a project for which the new employee is overqualified, and reducing a likelihood that a project is staffed by an underqualified employee. Based on matching a qualification of an employee to a project, cloud server 220 reduces a utilization of computing resources associated with completing the project, revising the project, or the like.

As indicated above, FIGS. 5A and 5B are provided merely as an example. Other examples are possible and may differ from what was described with regard to FIGS. 5A and 5B.

In this way, cloud server 220 ensures that an employee is objectively assessed for one or more skills based on experience obtained during assignment to one or more roles associated with one or more projects, thereby increasing accuracy of a skill proficiency level assessment relative to utilizing subjective criteria such as self-evaluation or supervisor-evaluation and reducing an amount of time relative to providing assessment surveys. Based on determining a skill proficiency level for a skill, cloud server 220 recommends (or, in another example, assigns) the employee to a task for which the employee is qualified, thereby improving a quality of work performed for the task, reducing a time associated with completing the task, and/or improving a likelihood of positive feedback received for the task relative to an underqualified employee being assigned to the task. Based on ensuring that a qualified employee is assigned to the task, cloud server 220 reduces a utilization of computing resources (e.g., processing resources or energy consumption) associated with completing the task, revising the task, or the like.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
communicate with a first server to obtain data regarding an entity,
the data being stored by a plurality of data structures of the first server;
process the data regarding the entity to determine information relating to one or more data entries of the data;
process the information relating to the one or more data entries of the data to generate a classification of the entity,
the classification of the entity being associated with a value corresponding to a particular data entry, of the one or more data entries, satisfying a threshold value;
generate one or more recommendations based on the classification of the entity,
the one or more recommendations relating to a role assignment for the entity; and
communicate with a second server to cause the one or more recommendations to be implemented for the entity.

2. The device of claim 1, where the one or more processors are further to:
receive a document associated with the entity;
parse the document using a natural language processing technique; and
update the classification of the entity to generate an updated classification based on parsing the document.

3. The device of claim 2, where the one or more processors are further to:
generate an updated recommendation based on the updated classification; and
communicate with the second server to cause the updated recommendation to be implemented.

4. The device of claim 1, where the one or more processors are further to:
determine a set of values for a set of entities,
the set of values corresponding to the value corresponding to the particular data entry;
determine the threshold value based on the set of values for the set of entities; and
where the one or more processors, when processing the information to generate the classification of the entity, are to:
process the information to generate the classification of the entity based on determining the threshold value.

5. The device of claim 1, where the one or more processors are to:
receive a report identifying a result of the role recommendation for the entity;
process the report to generate an updated classification of the entity based on the result of the task assignment for the entity;
generate another recommendation based on the updated classification of the entity,
the other recommendation relating to another role assignment; and
communicate with the second server to cause the other recommendation to be implemented for the entity.

6. The device of claim 1, where the entity is an employee; and
where the one or more processors, when processing the information relating to the one or more data entries to generate the classification, are to:
determine one or more skill proficiency levels relating to one or more skills of the employee based on a duration and a recency of one or more roles of the employee,
the one or more roles relating to one or more project assignments for the employee.

7. The device of claim 6, where the one or more processors, when communicating with the second server to cause the one or more recommendations to be implemented, are to:
cause the employee to be assigned to a particular role associated with a particular project based on the one or more skill proficiency levels,
the one or more skill proficiency levels satisfying a particular threshold associated with the particular role.

8. A non-transitory computer-readable medium storing instructions, the instructions comprising:
one or more instructions that, when executed by one or more processors, cause the one or more processors to:
identify a set of roles for a particular employee of a company,
each role, of the set of roles, being associated with a particular set of skills;
determine, for a particular role of the set of roles, a duration and a recency,
the particular role being associated with a particular skill;
determine a skill proficiency level, of a set of skill proficiency levels, for the particular skill based on the duration and the recency,
a value associated with the duration and the recency satisfying a threshold associated with the duration and the recency,
the threshold being associated with the skill proficiency level; and
provide information associated with the skill proficiency level based on determining the skill proficiency level.

9. The non-transitory computer-readable medium of claim 8, where the one or more instructions, when executed by the one or more processors, further cause the one or more processors to:
receive information identifying another particular role associated with a project of the company,
the other particular role requiring a threshold skill proficiency level;
determine that the skill proficiency level satisfies the threshold skill proficiency level required for the other particular role; and
where the one or more instructions, that cause the one or more processors to provide information associated with the skill proficiency level, cause the one or more processors to:
provide information associated with assigning the particular employee to the other particular role associated with the project.

10. The non-transitory computer-readable medium of claim 8, where the one or more instructions, when executed by the one or more processors, further cause the one or more processors to:
identify a proximate skill relating to the particular skill,
the particular employee being associated with a duration and a recency of the proximate skill; and
where the one or more instructions, that cause the one or more processors to determine the skill proficiency level for the particular skill, cause the one or more processors to:
determine the skill proficiency level based on the duration and the recency of the proximate skill.

11. The non-transitory computer-readable medium of claim 10, where the one or more instructions, that cause the one or more processors to identify the proximate skill relating to the particular skill, cause the one or more processors to:
perform a clustering analysis technique to determine that the proximate skill relates to the particular skill.

12. The non-transitory computer-readable medium of claim 8, where the one or more instructions, when executed by the one or more processors, further cause the one or more processors to:
determine a training recommendation relating to the particular skill based on determining the skill proficiency level; and
where the one or more instructions, that cause the one or more processors to provide information associated with the skill proficiency level, cause the one or more processors to:
provide information identifying the training recommendation.

13. The non-transitory computer-readable medium of claim 8, where the one or more instructions, when executed by the one or more processors, further cause the one or more processors to:
determine that the skill proficiency level fails to satisfy a particular threshold associated with assignment to another particular role for a particular project;
perform a cost-benefit analysis to determine a recommendation associated with the particular skill based on determining that the skill proficiency level fails to satisfy the particular threshold,
the recommendation relating to a hiring strategy, a training strategy, or a contracting strategy; and
where the one or more instructions, that cause the one or more processors to provide information associated with the skill proficiency level, cause the one or more processors to:
provide information identifying the recommendation.

14. The non-transitory computer-readable medium of claim 8, where the one or more instructions, when executed by the one or more processors, further cause the one or more processors to:
receive, after determining the skill proficiency level, a request to determine an updated skill proficiency level;
determine an updated recency based on receiving the request to determine the updated skill proficiency level;
determine the updated skill proficiency level based on the updated recency,
the updated skill proficiency level being less than the skill proficiency level; and
provide information identifying the updated skill proficiency level based on determining the updated skill proficiency level.

15. The non-transitory computer-readable medium of claim 8, where the one or more instructions, when executed by the one or more processors, further cause the one or more processors to:
receive, after determining the skill proficiency level, a request to determine an updated skill proficiency level,
the particular role continuing for a period of time after determining the skill proficiency level;
determine an updated duration for the particular role based on receiving the request to determine the updated skill proficiency level,
the updated duration being greater than the duration;
determine the updated skill proficiency level based on the updated duration,
the updated skill proficiency level being greater than the skill proficiency level; and
provide information identifying the updated skill proficiency level based on determining the updated skill proficiency level.

16. A method, comprising:
communicating, by a device, with one or more server devices including one or more data structures to receive data regarding a first plurality of roles assigned to a plurality of employees of a company;
processing, by the device, the data to determine the first plurality of roles assigned to the plurality of employees of the company;
determining, by the device and for each role of the first plurality of roles, a duration and a recency based on the data;
determining, by the device and for a set of skills associated with the first plurality of roles, a plurality of skill proficiency levels for the plurality of employees based on the duration and the recency for each role of the first plurality of roles;
automatically assigning, by the device, the plurality of employees to a second plurality of roles based on the plurality of skill proficiency levels for the plurality of employees; and
providing, by the device, information identifying the second plurality of roles.

17. The method of claim 16, further comprising:
determining, for a particular skill of the set of skills, another skill, of the set of skills, proximate to the particular skill; and
where determining the plurality of skill proficiency levels comprises:
determining a particular skill proficiency level, of the plurality of skill proficiency levels, of the particular skill and for a particular employee, of the plurality of employees, based on a particular duration and a particular recency of the other skill proximate to the particular skill.

18. The method of claim 16, further comprising:
identifying a particular skill, of the plurality of skills, as an emerging skill based on a frequency of occurrence of the particular skill in the first plurality of roles; and
where determining the plurality of skill proficiency levels comprises:
determining a particular set of skill proficiency levels relating to the particular skill based on identifying the particular skill as an emerging skill.

19. The method of claim 16, where determining the plurality of skill proficiency levels comprises:
receiving, for a particular skill proficiency level of the plurality of skill proficiency levels, validation information associated with validating a determination of the particular skill proficiency level,
the validation information indicating a different skill proficiency level than the particular skill proficiency level; and
adjusting the particular skill proficiency level to generate an adjusted skill proficiency level based on the validation information.

20. The method of claim 19, where automatically assigning the plurality of employees to the second plurality of roles comprises:
assigning a particular employee to a particular role, of the second plurality of roles, based on the adjusted skill proficiency level.
